(19) United States
(12) Patent Application Publication
(10) Pub. No.: US 2012/0126605 A1
(43) Pub. Date: May 24, 2012

(54) HEADREST AND VEHICLE SEAT

(75) Inventors: Bernd Gross, Langenfeld (DE); Hans-Georg Werner, Langenfeld (DE); Joshua Hesterberg, Mettmann (DE); Sachin Bharambe, Maharashtra (IN); Thomas Frotz, Burscheld (DE); Denis Quandt, Koeln (DE)

(73) Assignee: Johnson Control Technology Company, Holland, MI (US)

(21) Appl. No.: 13/260,894

(22) PCT Filed: Apr. 1, 2010
(86) PCT No.: PCT/EP10/02092

§ 371 Date: Jan. 12, 2012

(30) Foreign Application Priority Data
Apr. 1, 2009 (DE) 10 2009 015 251.2
Apr. 3, 2009 (DE) 10 2009 016 088.4
Apr. 3, 2009 (DE) 10 2009 016 090.6

(51) Int. Cl. B60N 2/48

(52) U.S. Cl. 297/410

(57) ABSTRACT

A vehicle headrest comprises means for retaining the headrest on the backrest as a vehicle seat. The headrest is adjustable vertically (Z-direction) in a reversible manner relative to the backrest, and at least partially with regard to its distance from the head of a seat occupant (X-direction). Such adjustments are carried out at least temporarily at the same time.

### BACKGROUND

The invention relates to a headrest and a vehicle seat provided therewith, in particular for a motor vehicle.

It is known from practical experience to adjust headrests or parts thereof in various spatial directions in order to adapt them as regards safety and comfort to the requirements of the respective seat occupant.

The object of the invention is to design the adjustment of a headrest, which is adjustable in a complex manner, to be particularly comfortable and using simple technical means.

The object is achieved by a headrest which is provided with at least one retaining means on the backrest of a vehicle seat and may be adjusted vertically (Z-direction, −Z-direction) in a reversible manner relative to the backrest and at least partially with regard to its distance from the head of the seat occupant (X-direction, −X-direction), wherein the adjustment is carried out at least temporarily at the same time. By the simultaneous adjustment of the headrest vertically and the distance of the headrest or parts thereof from the vehicle occupant, the adjustment is particularly comfortable and simple.

### SUMMARY

The present invention relates to a headrest which has a supporting structure which is generally provided at least partially with a padded portion, in particular on the side facing the seat occupant. Preferably, the supporting structure is designed in two parts, wherein most particularly preferably at least one of the two parts is of a trough-like design. Said headrest is provided on at least one, preferably two, retaining means, generally retaining bars on the backrest of a vehicle seat. With a vertical adjustment (Z-direction), generally the entire headrest is displaced. Preferably, in this case the adjustment takes place relative to the retaining means.

According to the invention, it is provided that the headrest or parts of the headrest may be adjusted relative to the distance thereof from the head of the seat occupant at least into a forward position, a rearward position and preferably at least one position of use located therebetween. Preferably, a plurality of further positions of use may be set between the forward and rearward positions of use. In this case, the direction of adjustment substantially corresponds to the seat direction of the seat occupant and, in a conventional seating arrangement, approximately the direction of travel (−X direction and/or X-direction of the vehicle).

Preferably, it is provided that the adjustment which is oriented toward the head of the occupant (−X-direction of the vehicle) is possible by simply pulling/pushing forward, i.e. without releasing the locking means of the headrest or headrest parts. Moreover, it is preferable that before restoring the headrest or parts thereof (X-direction of the vehicle) only one locking means has been released. However, it is also possible that the locking means also has to be released for an adjustment of the headrest or parts thereof in the direction of the seat occupant.

Preferably, the locking means is released by actuating a handle. This handle may comprise a push button, but may also be driven in a motorized manner. The handle is operatively connected to the locking means directly or indirectly, so that the handle is able to release the locking means. The operative connection may be mechanical, electrical, electromagnetic and/or hydraulic/pneumatic. Preferably, however, the push button acts directly on a part, for example a locking bar, which at least partially releases the locking of the headrest in the X-direction. Preferably, by actuating the handle, an adjustment is also possible with regard to the height of the headrest or parts thereof (Z-direction and/or −Z-direction of the vehicle).

Moreover, it is advantageously provided that the headrest comprises an adjustment mechanism for adjusting the distance from the head of the occupant, which is preferably arranged inside a particularly preferable trough-like or hollow padded part of the headrest and displaces said padded part or the headrest as a whole.

Preferably, the adjustment mechanism has a lever arrangement which particularly preferably comprises two vertical rotational axes which are spaced apart from one another. The rotation of the levers advantageously takes place around the retaining bars of the headrest protruding into the padded part. By means of the levers, a first part and a second part of the headrest may be moved relative to one another or the headrest may be moved as a whole.

The two levers in this case preferably rotate in opposing directions and are advantageously synchronized with regard to their rotational movement.

The synchronization takes place according to a first preferred embodiment by a linkage arrangement connecting the levers. In this case, the preferably horizontally extending connecting rod is advantageously connected in an articulated manner to a lever in front of the rotational axis thereof and to the other lever behind the rotational axis thereof.

The synchronization takes place according to a further preferred embodiment by a transmission shaft mechanically connecting the levers. The transmission shaft preferably extends horizontally and is provided at the end with gear wheels or gear wheel segments. Said gear wheels or gear wheel segments cooperate with gear wheels or gear wheel segments which are connected fixedly in terms of rotation to the levers. The gear wheels or gear wheel segments are advantageously of conical design and cooperate in the region of toothed portions provided on the conical surfaces.

In principle, however, the synchronization may also take place by other means, for example by toothed rods.

Preferably, the locking means, by which the movement of the headrest or parts thereof is prevented in at least one direction, comprises at least one means which is moved in a translatory manner, for example a locking bar. Particularly preferably, the headrest comprises two means which are moved in a translatory manner and which move in opposing directions. Most particularly preferably, the means prevents the movement of the headrest or parts thereof in the X-direction and in the Z-direction.

### DRAWINGS

The invention is described hereinafter with reference to FIGS. 1-10. These descriptions are provided merely by way of example and do not limit the general inventive idea.

FIG. 1 shows a headrest according to the invention in a perspective view from the front;

FIG. 2 shows the retaining bars and adjustment mechanism of the headrest according to FIG. 1 in a perspective view from the rear;

FIG. 3 shows a cross section through the headrest according to FIGS. 1 and 2 in the region of the support in a forward comfort setting (FIG. 3a) and a rearward comfort setting (FIG. 3b).

FIG. 4 shows a cross section through the headrest with a view of the levers and a linkage arrangement;

FIG. 5 shows a detail of the adjustment device of the headrest.

FIG. 6 shows a further headrest according to the invention in a perspective view from the front;

FIG. 7 shows a detail of the adjustment device of the headrest.

FIG. 8 shows a further headrest according to the invention in a perspective view from the front;

FIGS. 9, 10 show in each case a detail of the adjustment device of the headrest.

### DETAILED DESCRIPTION

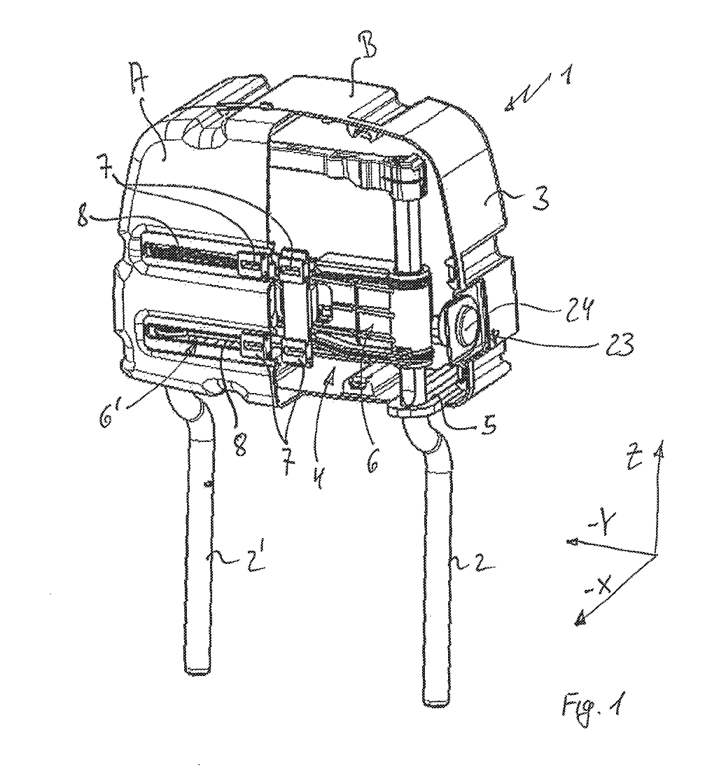

The headrest shown in FIG. 1 consists of two retaining bars 2 extending substantially vertically and spaced apart from one another in the transverse direction (Y-direction of the vehicle), which are inserted from the top into a backrest, not shown. The headrest 1 has a hollow, rigid support 3 made up from two half-shells A, B, and which is covered by a padded portion consisting of foam and a cover, not shown, and forms a padded part therewith. The support 3 is shown partially cut away in FIG. 1. The retaining bars 2 and the support 3 are connected together in a displaceable manner by an adjustment mechanism 4. The retaining bars 2 are in this case guided through slot-shaped recesses 5 on the underside of the support 3, so that said support may be displaced relative to the retaining bars 2, 2′ toward the head of the seat occupant (−X-direction of the vehicle).

The adjustment mechanism 4 comprises two levers 6, 6′ which are rotatably mounted on the retaining bars 2, 2′ about vertical rotational axes. Above the levers 6, 6′ the retaining bars 2, 2′ are connected together by a horizontal bridging piece 18 positioned thereon.

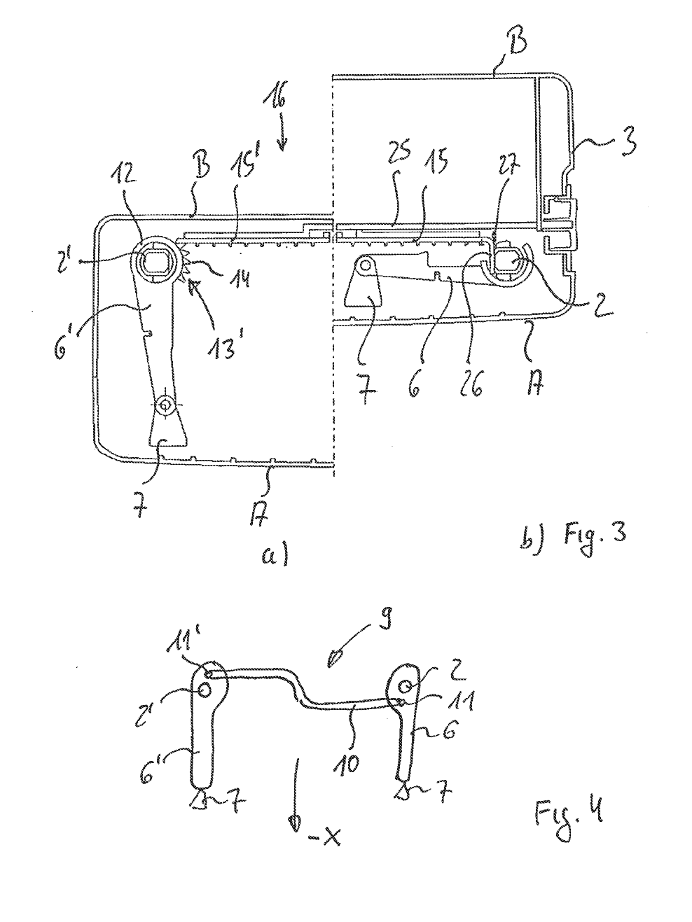

The levers 6, 6′ have sliding pieces 7 attached in an articulated manner to the ends thereof and which are displaceably guided in sliding guides 8 extending transversely in the front half-shell A of the support 3. The sliding pieces 7 preferably consist of a low-friction plastics material, for example POM (polyoxymethylene). The levers 6, 6′ have a first rotational position in which they are oriented transversely to the seat direction and toward one another (FIG. 3b). Said lever position defines the rearward position of use of the headrest 1. The levers 6, 6′ may also be rotated to the front into a position facing the seat direction (FIG. 3a). Said lever position defines the forward position of use of the headrest 1. A plurality of intermediate positions which are also provided as positions of use, are located therebetween.

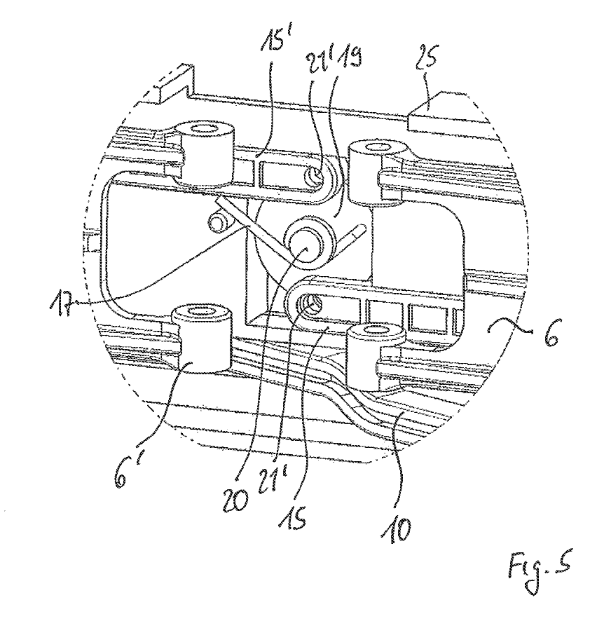

The levers 6, 6′ are synchronized via a linkage arrangement 9, comprising a horizontal connecting rod 10, shown in FIG. 4, which is connected via joints 11, 11′ to the levers 6, 6′. In this case, the right-hand joint 11′ is arranged behind the retaining bar 2′ and the left-hand joint 11 is arranged in front of the retaining bar 2. The connecting rod 10 extends therebetween, bent at an angle. With a rotation of the lever 6, therefore, the lever 6′ is always rotated in the opposing direction, whereby all sliding pieces 7 and thus also the support 3 are displaced synchronously in, or counter to, the seat direction.

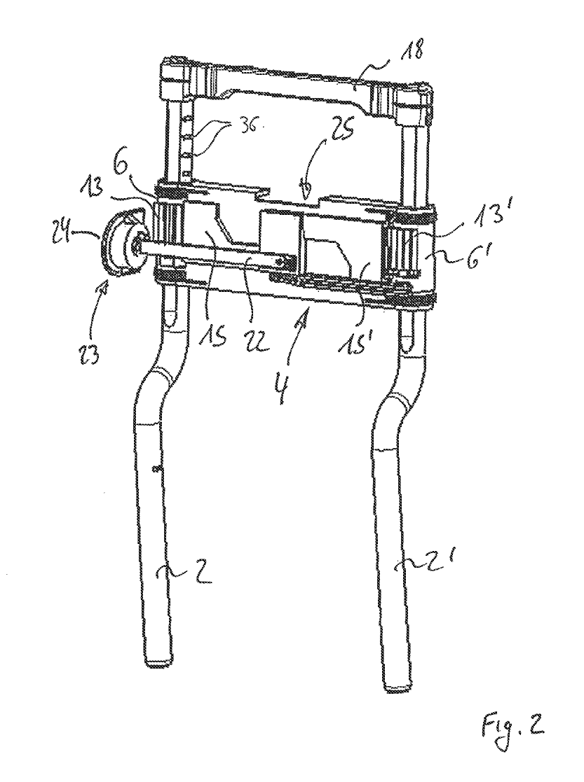

The lever 6′, as visible from FIG. 3a, is provided in the region of a sleeve-like shaped portion 12 surrounding the retaining bar 2′, beyond a part of the outer periphery of this shaped portion 12, with a toothed portion 13′ with vertically extending teeth 14 which are in engagement with a locking bar 15′ as part of a locking device 16. The locking bar 15′ is displaceable in a translatory manner, preferably horizontally transversely to the seat direction and particularly preferably pretensioned by means of a spring means (leg spring 17) in the direction of the toothed portion 13. A locking bar 15 acting in the opposing direction engages in a toothed portion 13 on the lever 6 (see FIG. 2). The toothed portions 13, 13′ and the locking bars 15, 15′ may be configured by integrally forming oblique surfaces which cooperate with one another so that it is also possible to pull forward the support 3 of the headrest 3 in a ratchet-type manner in the locked state.

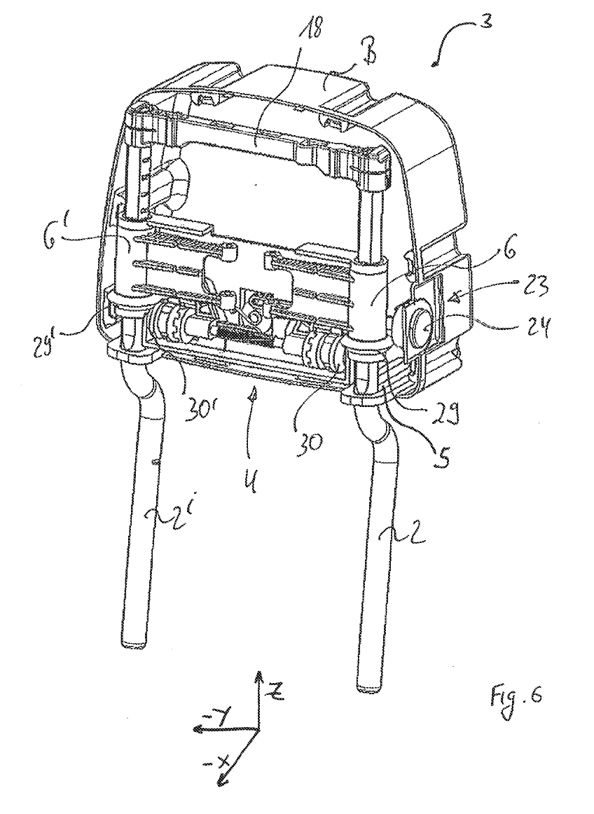

The locking bars 15, 15′ are connected together via a rotational body 19 (see FIG. 5) which is rotatable about a horizontal pivot pin 20 extending in the seat direction (−X-direction of the vehicle) on a crossmember 25 of the adjustment mechanism 4 which is vertically displaceable on the retaining bars 2, 2′. The leg spring 17 is wound around this pivot pin 20 and pretensions the rotational body 19 in one rotational direction. The locking bar 15′ is connected in an articulated manner above the pivot pin 20 to the rotational body 19 and the locking bar 15 is connected in an articulated manner below the pivot pin 20 to the rotational body 19 in joints 21, 21′, so that the locking bars 15, 15′ are displaced in opposing directions when the rotational body 19 is rotated. Moreover, the transmission rod 22 of a handle 23 acts eccentrically on the rotational body 19, said handle being configured as a push button 24. When the push button 24 is pressed, the transmission rod 22 rotates the rotational body 19 counter to the force of the leg spring 17 and thus pulls the locking bars 15, 15′ toward one another. As a result, the locking bars come out of engagement with the toothed portions 13, 13′ so that a displacement of the support 3 is possible not only toward the head of the occupant but also in the opposing direction (−X direction and/or X-direction of the vehicle).

When actuating the handle 23, which is arranged in this case to the side in the rear half-shell B, at the same time a projection 26 provided on the locking bar 15 in the region of the retaining bar 2 and protruding to the front is pushed away from the retaining bar 2 and which in the locked position engages in one of a plurality of horizontal notches 36 incorporated on the inside of the retaining bar 2 and secures the support 3 with regard to its vertical position on the retaining bars 2, 2′. By actuating the handle 23, therefore, a simultaneous adjustment of the headrest is possible in the Z-direction and X-direction of the vehicle.

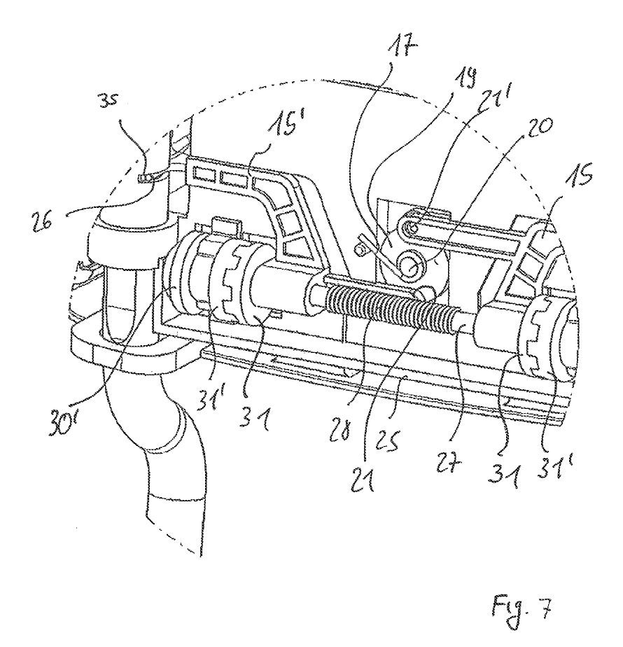

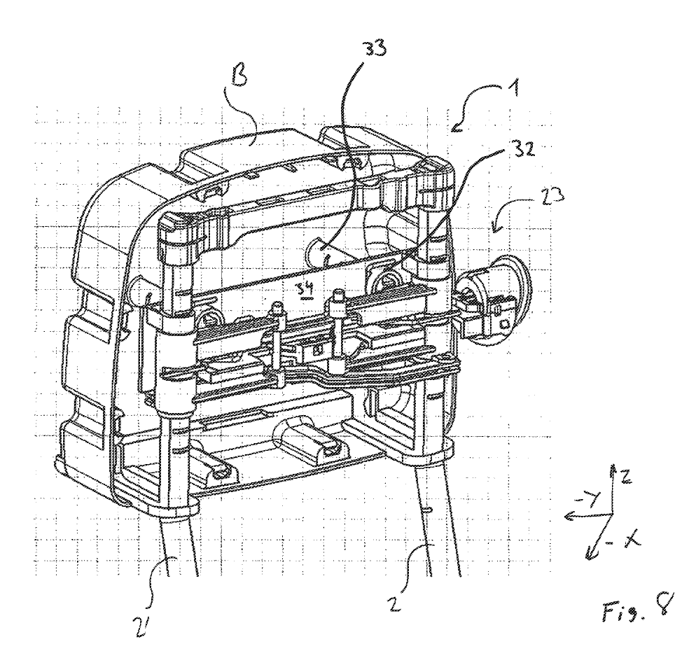

FIGS. 6 and 7 show a further embodiment of the headrest according to the invention. The headrest shown in FIGS. 6 and 7 consists of two retaining bars 2 extending substantially vertically and spaced apart from one another in the transverse direction (Y-direction of the vehicle) which are inserted from the top into a backrest, not shown. The headrest 1 has a hollow, rigid support 3 made up from two half-shells, and which is covered by a padded portion consisting of foam and a cover, not shown, and forms a padded part therewith. In FIG. 6 only the rear half-shell B of the support 3 is shown. The retaining bars 2 and the support 3 are connected together in a displaceable manner by an adjustment mechanism 4. The retaining bars 2 are in this case guided through slot-shaped recesses 5 on the underside of the support 3, so that said support may be displaced relative to the retaining bars 2, 2′ toward the head of the seat occupant (−X-direction of the vehicle).

The adjustment mechanism 4 comprises two levers 6, 6′ which are rotatably mounted on the retaining bars 2, 2′ about vertical rotational axes. Above the levers 6, 6′ the retaining bars 2, 2′ are connected together by a horizontal bridging piece 18 positioned thereon.

The levers 6, 6′ have sliding pieces attached in an articulated manner to the ends thereof and which are displaceably guided in sliding guides extending transversely in the front half-shell of the support 3. The sliding pieces preferably consist of a low-friction plastics material, for example POM (polyoxymethylene). The levers 6, 6′ have a first rotational position in which they are oriented transversely to the seat direction and toward one another (FIG. 3b). Said lever position defines the rearward position of use of the headrest 1. The levers 6, 6′ may also be rotated to the front into a position facing the seat direction (FIG. 3a). Said lever position defines the forward position of use of the headrest 1. A plurality of intermediate positions which are also provided as positions of use, are located therebetween.

The synchronization of the levers 6, 6′ is carried out by a transmission shaft 27 which extends horizontally between the retaining bars 2, 2′ and is rotatably mounted on a crossmember 25 of the adjustment mechanism 4. The transmission shaft 27 and thus also the levers 6, 6′ are preferably pretensioned in the direction of a forward position of use of the headrest 1 via a spring means 28 wound around the transmission shaft 27. Conical gear wheels 29, 29′, 30, 30′ integrally formed on the ends of the transmission shaft 27 and on the undersides of the levers 6, 6′ serve for transmitting moments, and which are provided on their conical surfaces with toothed portions which mesh with one another and preferably are integrally formed by injection-molding onto the levers 6, 6′ and/or the transmission shaft 27.

On the shaft of the transmission shaft 27, moreover, as visible from FIG. 2, two locking bars 15, 15′ are rotatably mounted in a displaceable manner in opposing directions, and which at their outer ends are provided in the region of the retaining bars 2, 2′ with projections 26 protruding to the front. The locking bars 15, 15′ are connected with their inwardly protruding ends via joints 21, 21′ to a rotational body 19. The rotational body 19 is rotatably mounted on the crossmember 25 via a horizontal, forwardly protruding pivot pin 20, and pretensioned by means of a leg spring 17 in one rotational direction. The joints 21, 21′ are arranged above and/or below the pivot pin 20 on the rotational body 19 such that the locking bars 15, 15′ are outwardly pretensioned by the leg spring 17 in opposing directions. As a result, the projections 26 are forced into horizontal notches 36 on the inside of the retaining bars 2, 2′ and secure the headrest 1 with regard to its height (Z-direction of the vehicle).

On the locking bars 15, 15′ which are transversely displaceable relative to the crossmember 25 but fixed in terms of rotation, moreover, coupling pieces 31 comprising axially outwardly protruding claws are integrally formed coaxially to the rotational axis of the transmission shaft 27, and which positively cooperate with coaxial coupling pieces 31′ comprising inwardly protruding claws and integrally formed on the transmission shaft 27. When the claws engage with one another the coupling pieces 31′ and thus the transmission shaft 27 are, as a whole, locked in terms of rotation so that an adjustment of the headrest 1 in the direction of travel is prevented.

A handle 23 in the form of a push button 24 is arranged to the side on the rear half-shell B, and which acts directly on the locking bar 15. When pushed in, the locking bar 15 is pushed toward the center of the crossmember 25. This displacement is transmitted to the other locking bar 15′ in the opposing direction by the rotational body 19. As a result, the projections 26 firstly come out of engagement with the notches 36 and, secondly, the coupling pieces 31 come out of engagement with the corresponding coupling pieces 31′. Subsequently, the headrest 1 is able to be adjusted both in the seat direction and also with regard to its height. When the push button 24 is released, it is blocked again in both spatial directions.

The person skilled in the art recognizes that the rotational blocking of the transmission shaft 27 may also be carried out by a gear wheel connected fixedly in terms of rotation thereto, a latching pawl, for example, engaging in the teeth thereof for rotational locking. This latching pawl is then, for example, also brought in and out of engagement with the gear wheel by the translatory movement of the locking bar 15. To this end, the locking bar comprises cams, for example.

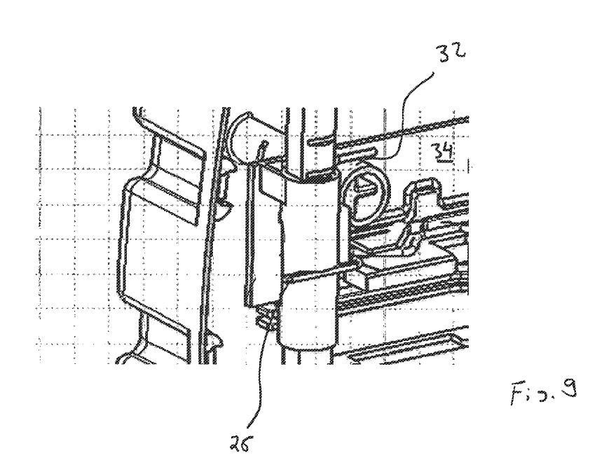

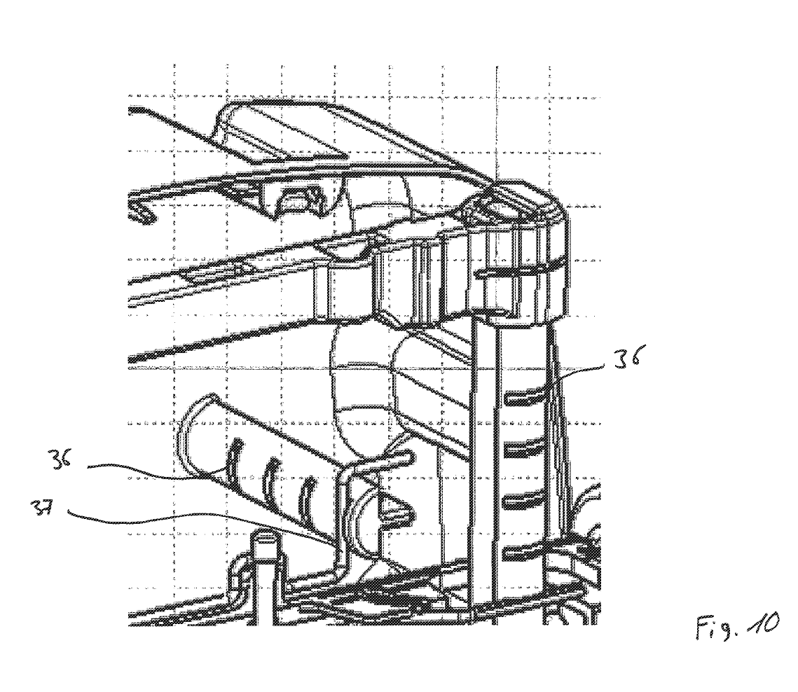

FIGS. 8-10 show a further embodiment of the headrest according to the invention which is relatively similar to the headrests according to FIGS. 1 to 7 so that reference may be made to the embodiments provided there. In this headrest the adjustment mechanism 4 is different. In this adjustment mechanism, the support plate 34 is provided with two guide means 32, in this case guide bushes. Said bushes in each case have a slot at the side. Preferably cylindrical latching elements 33 attached to the shell B are inserted into these bushes. The guide bush 32 and the latching element 33 constitute the guidance of the movement of a headrest part in the X-direction. The latching elements are also in each case provided with latching notches 36. A locking means 37 engages in a latching manner in the slot in the guide sleeve and in the latching notch 36. A sliding element is mounted in a translatory manner, preferably in a horizontally slidable manner on the support plate. Said sliding element is displaced horizontally by a handle 23 arranged on the headrest so that the locking means 37 is pulled out of the slots of the guide bushes 32 and the latching notches 36 of the latching elements 33. As a result, the headrest may be adjusted in a linear manner toward the head or away from the head of the seat occupant. At the same time, during this displacement movement unlocking means which are mounted on the sliding element are preferably moved counter to the force of a leaf spring, preferably in a translatory manner to the front out of the latching notches 36 of the retaining bar 2, 2′. Thus the vertical adjustment of the headrest is released. When releasing the handle, the headrest is blocked again in both spatial directions.

### LIST OF REFERENCE SYMBOLS

1 Headrest
2, 2′ Retaining means, retaining bar
3 Support
4 Adjustment mechanism
5 Recess
6, 6′ Lever
7 Sliding piece
8 Sliding guide
9 Linkage arrangement
10 Connecting rod
11, 11′ Joint
12 Shaped portion
13, 13′ Toothed portion
14 Tooth
15, 15′ Locking bar
16 Locking device
17 Leg spring
18 Bridging piece
19 Rotational body
20 Pivot pin
21, 21′ Joint
22 Transmission rod
23 Handle
24 Push button
25 Crossmember
26 Projection
27 Transmission shaft
28 Spring means
29, 29′ Gear wheel
30, 30′ Gear wheel
31, 31′ Coupling piece
32 Receiver, sleeve
33 Latching element, cylinder
34 Support plate
35 Slot
36 Notch
37 Locking means, wire
A, B Half-shell

1. A headrest, comprising at least one means for retaining the headrest on the backrest of a vehicle seat, wherein the headrest is adjustable vertically (Z-direction) in a reversible manner relative to the backrest and at least partially with regard to its distance from the head of the seat occupant (X-direction), wherein such adjustments are carried out at least temporarily at the same time.

2. The headrest as claimed in claim 1, wherein at least one locking device that prevents the adjustment in at least one direction.

3. The headrest as claimed in claim 2, wherein comprising a handle which actuates the locking means.

4. The headrest as claimed in claim 1, wherein comprising two levers by which a first part and a second part of the headrest are movable relative to one another or by which the headrest is movable as a whole.

5. The headrest as claimed in claim 4, wherein the levers are synchronized.

6. The headrest as claimed in claim 2, wherein the locking device comprises at least one locking bar moved in a translatory manner.

7. The headrest as claimed in claim 6,
comprising two locking bars movable in a translatory manner and in opposing directions.

8. The headrest as claimed in claim 2, wherein the locking device prevents movement of the headrest or parts thereof in the X-direction and in the Z-direction.

9. The headrest as claimed in claim 8, wherein prevention of movement in the X-direction and in the Z-direction may be activated and/or deactivated substantially at the same time.
